(19) United States
(12) Patent Application Publication
(10) Pub. No.: US 2007/0282488 A1
(43) Pub. Date: Dec. 6, 2007

(54) METHOD AND DEVICE FOR DISPLAYING IMAGES IN VEHICLES

(75) Inventors: Kazuhito Kato, Yokohama-shi (JP); Haruo Takezawa, Yokosuka-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO. LTD., Yokohama-shi (JP)

(21) Appl. No.: 11/755,286

(22) Filed: May 30, 2007

(30) Foreign Application Priority Data
May 31, 2006 (JP) JP2006-151704

(51) Int. Cl. G06F 17/00; G01C 21/32

(52) U.S. Cl. 701/1; 701/200; 340/995.1

(57) ABSTRACT

A device and method for displaying images in a vehicle selectively moves an image so as to cancel out the detected displacement of a vehicle or the head of an occupant. When the image is displaced, the device moves markers in accordance with a displacement direction and a displacement amount of the image. In particular, the device displays at least one pair of markers along opposing edges of the screen. One pair of markers can be adjacent to the upper and lower edges of the display screen, while a second pair of markers can be adjacent to the left and right edges of the display screen. Accordingly, no marker appears at the center of the image. Further, although a fixed marker is not displayed, each of the sides of the screen serves the functions of a fixed marker, preventing obstruction of the image due to a conventional fixed marker.

### CROSS-REFERENCE TO RELATED APPLICATION

This application claims priority from Japanese Patent Application Serial No. 2006-151704, filed May 31, 2006, which is incorporated herein in its entirety by reference.

### TECHNICAL FIELD

The invention relates in general to a device for displaying images in vehicles and a method for displaying images in vehicles.

### BACKGROUND

There are known devices for displaying images in vehicles wherein an image to be displayed on an image display is shifted so as to cancel out the motion of a vehicle. For example, in Japanese Unexamined Patent Application Publication No. 2004-354481, an image to be displayed on the image display is shifted to cancel out the motion of the vehicle in accordance with the motion of the vehicle, a marker is displayed on the image display at the center of the image and is moved in accordance with the motion of the image, and a marker is displayed on the image display at a fixed location with respect to the image display. With this device, the movable marker and the fixed marker allow a user watching the image in the vehicle to recognize the motion of the image, thus preventing the user from experiencing an incongruous or uncomfortable feeling.

### SUMMARY

Devices for displaying images in a vehicle including a display unit having a screen are taught herein. One device taught herein comprises a motion estimating unit operable to estimate an estimated displacement value corresponding to at least one of an estimated displacement of the vehicle and an estimated displacement of a head of an occupant and a display control unit. The display control unit is operable to display an image on the screen, selectively displace the image with respect to the screen according to the estimated displacement value, display a pair of markers disposed along opposing edges of the screen and move the pair of markers in accordance with a displacement direction and a displacement amount of the image when the image is displaced.

Another example of such a device comprises means for estimating an estimated displacement value corresponding to at least one of a displacement of a vehicle and a displacement of the head of an occupant means for selectively displacing an image displayed on the screen according to the estimated displacement value and means for moving a pair of markers disposed along opposing edges of the screen in accordance with a displacement direction and a displacement amount of the image when the image is displaced.

Methods of displaying images in a vehicle including a display unit having a screen are also taught herein. One example of such a method comprises estimating an estimated displacement value corresponding to at least one of a displacement of a vehicle and a displacement of the head of an occupant, selectively displacing an image displayed on the screen according to the estimated displacement value and moving a pair of markers disposed along opposing edges of the screen in accordance with a displacement direction and a displacement amount of the image when the image is displaced.

### BRIEF DESCRIPTION OF THE DRAWINGS

The description herein makes reference to the accompanying drawings wherein like reference numerals refer to like parts throughout the several views, and wherein:

FIG. 1 is a block diagram showing the configuration of a device for displaying images in vehicles according to a first embodiment of the invention;

FIG. 2 is a schematic illustration showing a method of estimating the displacement of a vehicle by a vehicle motion estimating section shown in FIG. 1;

FIG. 3 is a schematic illustration showing a method of estimating the motion of a head of an occupant by an occupant motion estimating section shown in FIG l;

FIG. 4 is a schematic illustration showing an example of displaying markers;

FIG. 5 is a schematic illustration showing another example of displaying markers;

FIG. 6A is a schematic illustration showing displacement of an image by an image displacement section wherein the image is vertically displaced;

FIG. 6B is an illustration showing displacement of an image by an image displacement section wherein the image is horizontally displaced;

FIG. 7 is a schematic illustration showing an example of a device for displaying images in vehicles installed in a vehicle cabin;

FIG. 8 is a flowchart showing a method for displaying images in vehicles according to the first embodiment;

FIG. 9A is a schematic illustration showing a relative positional relationship between an occupant and a display screen during displacement of a vehicle;

FIG. 9B is a schematic illustration showing the displacement of an image in accordance with the displacement of a vehicle when a nose-dive phenomenon of the vehicle occurs,

FIG. 9C is a schematic illustration showing the displacement of an image in accordance with the displacement of a vehicle when a squatting phenomenon of the vehicle occurs;

FIG. 10A is a schematic illustration showing a relative positional relationship between an occupant and a display screen during the displacement of the head of the occupant;

FIG. 10B is a schematic illustration showing the displacement of an image in accordance with the displacement of the head of an occupant;

FIG. 11 is a table showing the details of estimation of the displacement of a vehicle and estimation of the displacement on the head of an occupant in various travel states;

FIG. 12 is a block diagram showing the configuration of a device for displaying images in vehicles according to a second embodiment;

FIG. 13 is a schematic illustration showing estimates of the amount of roll rotation by a vehicle motion estimating section;

FIG. 14A is a schematic illustration showing a method of generating markers by a marker generation section when a vehicle is not in roll rotation;

FIG. 14B is a schematic illustration showing a method of generating markers by a marker generation section when a vehicle is in roll rotation; and

FIG. 15 is a flowchart showing a method for displaying images in vehicles according to the second embodiment.

### DETAILED DESCRIPTION OF EMBODIMENTS OF THE INVENTION

According to the vehicle image-displaying device of the related art, the movable marker is displayed at the center of the image. Hence, the movable marker may be obstructive for the user. Also, since the fixed marker is necessarily displayed so that the user can easily recognize the motion of the movable marker, the fixed marker may be further obstructive for the user.

In contrast, and as taught herein, a display control unit can display a pair of markers diagonally disposed along opposing edges of the screen and move the markers according to the displacement of the image when the image is displaced. Certain embodiments of the invention are described below with reference to the attached drawings.

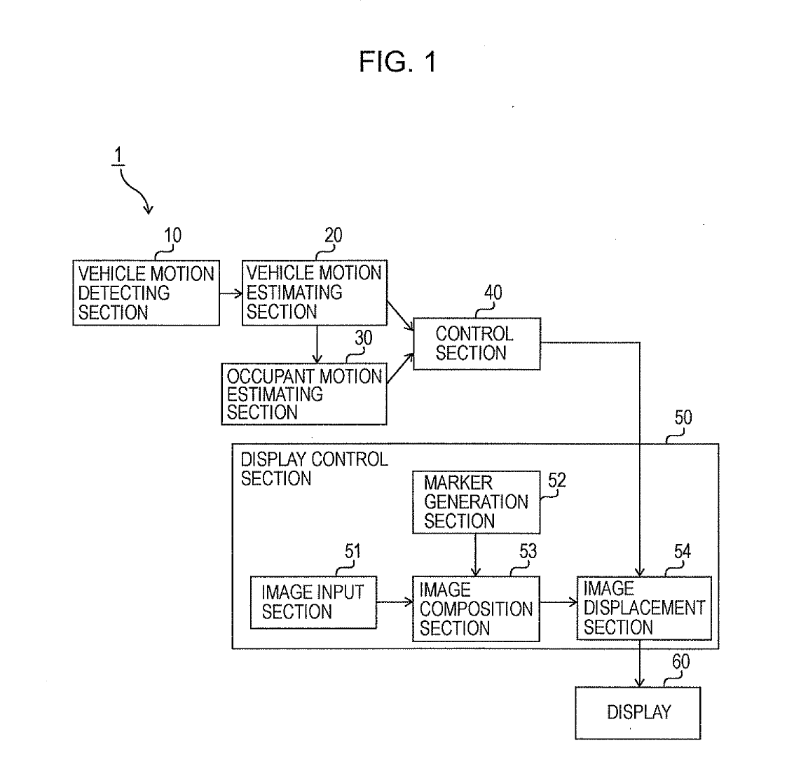

FIG. 1 is a block diagram showing the configuration of a device for displaying images in vehicles according to a first embodiment. As shown in the drawing, this vehicle image-displaying device 1 includes a vehicle motion detecting section 10, a vehicle motion estimating section (motion estimating unit) 20, an occupant motion estimating section (motion estimating unit) 30, a control section 40, a display control section (display control unit) 50 and a display (display unit) 60.

The vehicle motion detecting section 10 has an acceleration sensor, an angular speed sensor, and the like, by which it detects, for instance, the acceleration applied to a vehicle (acceleration in the translational direction) and the angular speed applied to the vehicle.

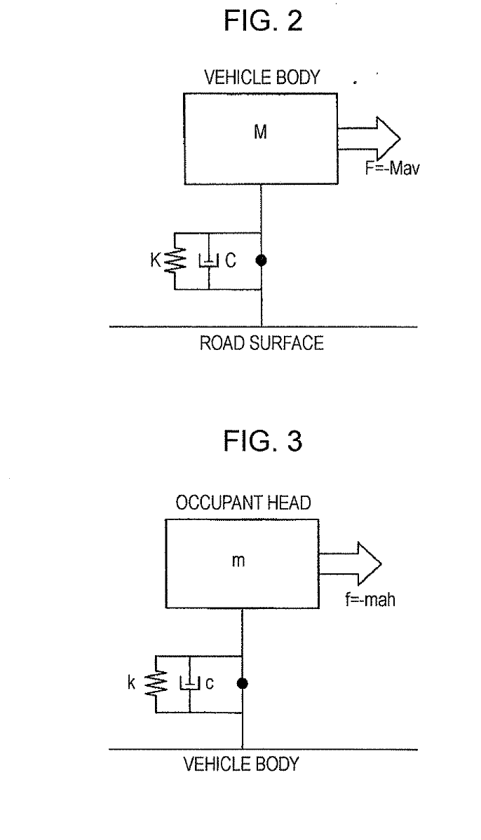

The vehicle motion estimating section 20 estimates the displacement of the vehicle based on the acceleration and the like detected by the vehicle motion detecting section 10. For example, the vehicle motion estimating section 20 estimates the displacement of the vehicle using a vehicle behavior model shown in FIG. 2.

FIG. 2 is a schematic illustration showing a method of estimating the displacement of the vehicle by the vehicle motion estimating section 20. As shown in FIG. 2, the vehicle behavior model is a combination of a vehicle body model having a mass M and a suspension model having a spring modulus K and a damping coefficient C. When a deceleration av is applied to the vehicle body of this model, the vehicle body moves forward by a predetermined amount (in a direction indicated by the arrow shown in the drawing). The vehicle motion estimating section 20 stores data of the movement direction and the movement amount of the vehicle body obtained in advance for different accelerations applied to the vehicle behavior model. The vehicle motion estimating section 20 estimates the displacement of the vehicle (movement direction and movement amount) on the basis of the acceleration and the like detected by the vehicle motion detecting section 10.

Note that the mass M of the vehicle body varies in accordance with the number of occupants (loading weight) detected by a sensor (not shown). Owing to this, the vehicle motion estimating section 20 stores data of the movement direction and the movement amount of vehicle body obtained in advance for the different accelerations applied to different numbers of occupants (different preset amounts of loading weights).

Referring back to FIG. 1, the occupant motion estimating section 30 estimates the displacement of the head of the occupant based on the motion of the vehicle estimated by the vehicle motion estimating section 20. For example, the occupant motion estimating section 30 estimates the displacement of the head of the occupant using an occupant behavior model shown in FIG. 3.

FIG. 3 is a schematic illustration showing a method of estimating the displacement of the head of the occupant by the occupant motion estimating section 30. As shown in FIG. 3, the occupant behavior model is a combination of an occupant head model having a mass m and an occupant body model having a spring modulus k and a damping coefficient c. When a deceleration ah is applied to the head of the occupant of this occupant behavior model, the head of the occupant moves forward by a predetermined amount (in a direction indicated by the arrow shown in the drawing). The occupant motion estimating section 30 stores data of the movement direction and the movement amount of the occupant's head obtained in advance for the different accelerations applied to the occupant behavior model. The occupant motion estimating section 30 estimates the displacement of the occupant's head (movement direction and movement amount) on the basis of the acceleration and the like detected by the vehicle motion detecting section 10.

Note that the mass m of the occupant's head, spring modulus A and damping coefficient C are varied in accordance with the type of physique of the occupant such as the weight, height, with the sitting height, and with the sitting posture of the occupant. The occupant motion estimating section 30 stores data of the movement direction and the movement amount of the occupant's head obtained in advance for the different accelerations applied to different types of physique or sitting posture of the occupant.

Referring back to FIG. 1, the control section 40 controls the entire vehicle image-displaying device 1. In particular, the control section 40 provides the movement amount of a display screen of the display 60 on the basis of the displacement of the vehicle estimated by the vehicle motion estimating section 20. Also, the control section 40 provides the displacement amount of the position of the occupant's eyes on the basis of the displacement of the head of the occupant estimated by the occupant motion estimating section 30. Then, the control section 40 calculates the amount of relative displacement between the display screen and the occupant's eye on the basis of the movement amount of the display screen of the display 60 and the displacement amount of the position of the occupant's eye.

The display control section 50 generates an image to be displayed on the display 60. The display control section 50 includes, for example, an image input section 51, a marker generation section 52, an image composition section 53 and an image displacement section 54.

The image input section 51 inputs information, such as a displayed image, video picture and text data, to be provided to a driver through the display 60. The marker generation section 52 generates a marker to be superposed on the displayed image and the like input by the image input section 51. The image composition section 53 composites the displayed image, etc., input by the image input section 51 and the marker generated by the marker generation section 52.

In particular, the marker generation section 52 generates a pair of markers that are diagonally disposed adjacent to upper and lower sides of the display screen. Alternatively, the marker generation section 52 may generate a pair of markers so as to be diagonally disposed adjacent to left and right sides of the display screen. Accordingly, the markers are displayed adjacent to the sides of the display screen of the display 60.

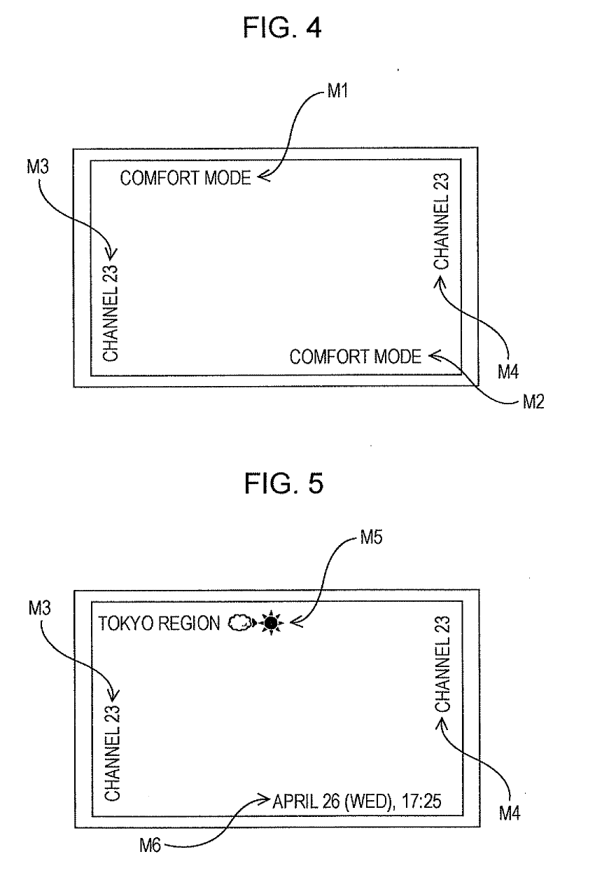

FIG. 4 is a schematic illustration showing an example of the display of such markers. As shown in the drawing, a pair of markers M1 and M2 are displayed adjacent to the upper and lower sides of the display screen. The pair of markers M1 and M2 are disposed diagonally. A pair of markers M3 and M4 are displayed adjacent to the left and right sides of the display screen. The pair of markers M3 and M4 are also disposed diagonally. Each of the markers M1 to M4 is displayed in an area spaced away from the corresponding one of the sides of the screen to have a spatial frequency ranging from 0.2 to 2.0 cycles/degree.

Each of the markers M1 to M4 is expressed as a character string indicating the condition or the state of the vehicle or the in-vehicle devices. For example, the markers M1 and M2 are each expressed as a character string indicating the mode of a shock absorber, “comfort mode”, whereas the markers M3 and M4 are each expressed as a character string indicating the channel of a television, “channel 23”. The character strings may not be those shown in FIG. 4, and may be air-conditioning information (e.g., setting of temperature, active air outlets, airflow rate or outside air temperature) or traffic information (e.g., expected time to reach the destination, text information of traffic congestion, regional information or shop information), etc. There are the following another the pair of markers elsewhere. For example, the pair of markers may have a marker disposed along the upper side (M1) and another marker disposed along a lower side(M2), and have a marker disposed along the upper side(M1) and another maker disposed along the right side(M3) or the left side(M4) of the screen.

FIG. 5 is a schematic illustration showing another example of displaying markers where the opposed markers are not identical. As shown in the drawing, markers M5 and MG illustrated in FIG. 5 may be displayed instead of the markers M1 and M2 each indicating “COMFORT MODE”. In particular, the marker M5 including a character string indicating “TOKYO REGION” and a graphic indicating cloudy, and the marker M6 including a character string indicating “APRIL 26 (WED), 17:25”, may be displayed. The marker may be expressed by such a graphic indicating the condition or the state of weather or the like. Also, the marker may be expressed by a symbol rather than a graphic.

As shown in FIGS. 4 and 5, the markers M1, M2, M5 and M6 each have a larger horizontal length than a vertical length thereof, and the markers M3 and M4 each have a larger vertical length than a horizontal length thereof. Accordingly, the vertical lengths of the markers M1, M2, MS and M6 adjacent to the upper and lower sides can be prevented from increasing, and the markers M1, M2, M5 and M6 can be prevented from extending to a center portion of the image. The horizontal lengths of the markers M3 and M4 adjacent to the left and right ends can also be prevented from increasing, and the markers M3 and M4 can be prevented from extending to the center portion of the image.

Referring again to FIG. 1, the image displacement section 54 displaces the position of the image displayed on the display 60 in accordance with the amount of relative displacement between the screen and the occupants eye calculated by the control section 40, With this displacement, the image displacement section 54 allows the displacement of the vehicle to cancel out the displacement of the head of the occupant. In particular, the image displacement section 54 displaces the position of the image in vertical and horizontal directions of the vehicle. The image can be provided without the occupant experiencing the incongruous feeling due to the movement of the vehicle in the vertical (pitch) and horizontal (roll) directions and the movement of the head of the occupant in the vertical (pitch) and horizontal (roll) directions.

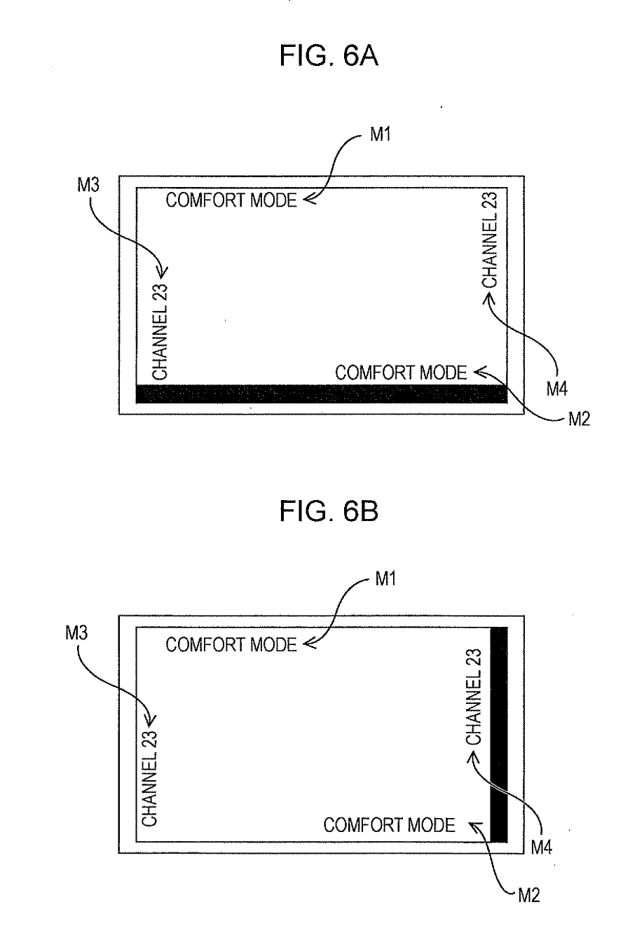

FIGS. 6A and 6B are schematic illustrations each showing the displacement of an image by the image displacement section 54. FIG. 6A shows a case where an image is vertically displaced, and FIG. 6B shows a case where an image is horizontally displaced.

For example, when a nose-down phenomenon of the vehicle occurs, the image displacement section 54 displaces the image upward to cancel out the displacement of the vehicle due to the nose-down phenomenon as shown in FIG. 6A. When the vehicle turns right, the image displacement section 54 displaces the image leftward to cancel out the displacement of the vehicle due to the right turn as shown in FIG. 6B.

As shown in FIGS. 6A and 6B, when the image is displaced, the image displacement section 54 moves the markers in the same direction as the displacement direction of the image by the same amount as the displacement amount of the image. The motion of the markers allows the user to easily recognize the motion of the image. To be more specific, because of the presence of the markers, the user can recognize the motion of the image by way of the motion of the markers. If a movable marker is displaced adjacent to a fixed marker and the user recognizes the relative movement between both, the power for detecting the motion of the image can be triple that as in the case where a movable marker is only displayed. However, the fixed marker is constantly located at the same position, and this may be obstructive for the user because a part of the image is sometimes not visible. In this embodiment, the fixed marker is not provided. Each marker is disposed adjacent to a side of the screen and moved in accordance with the displacement of the image. It has been discovered that the same effect is provided by the side of the screen as that provided by the fixed marker. Thus, elimination of the fixed marker can reduce obstruction of the image.

When displacing each of the markers in accordance with the displacement of the image, the image displacement section 54 expresses the marker such that a part of the marker, or the entire marker, is moved outside the side of the screen if the displacement amount is large. By moving the marker without being limited by the side of the screen, incongruous feeling and uncomfortable feeling may be lightened as compared with the case with the limitation.

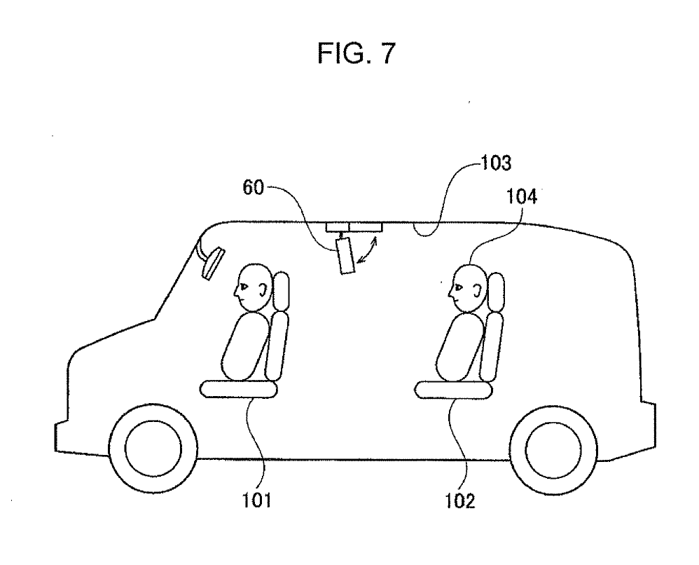

The display 60 displays the image displaced by the image displacement section 54 with the markers to the occupant of in vehicle. FIG. 7 is a schematic illustration showing an example of installation of the display 60 shown in FIG. 1. As shown in FIG. 7, the display 60 is installed at a roof portion 103 at an intermediate position between front and rear seats 101 and 102 in a vehicle cabin. The display 60 is of a retractable type. An occupant 104 sitting on the rear seat watches and recognizes the displayed image by tilting the display 60 downward.

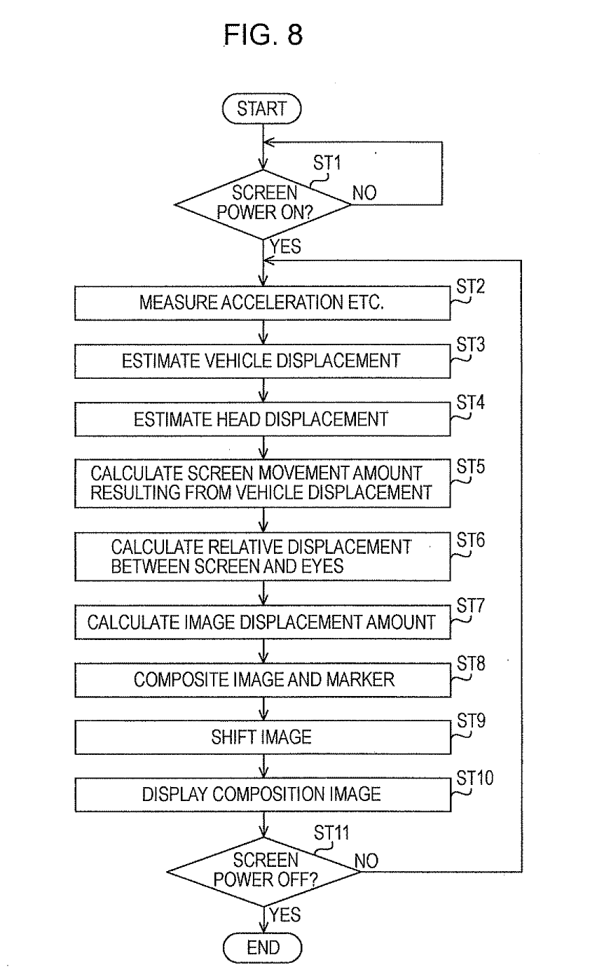

FIG. 8 is a flowchart showing the method for displaying images in vehicles according to the first embodiment. When the power of the vehicle image-displaying device I is ON, processing shown in FIG. 8 is started.

First, the control section 40 determines whether the power of the screen is ON, namely, whether the power of the display 60 is ON (ST1). When it is determined that the power of the display 60 is OFF (ST1: NO), the processing is repeated until the power is ON.

When the power of the display 60 is ON (ST1; YES), the vehicle motion detecting section 10 detects the acceleration and the like (ST2). The vehicle motion estimating section 20 estimates the displacement of the vehicle based on the acceleration and the like detected in step ST1 and the data of the vehicle behavior model shown in FIG. 2 (ST3). The occupant motion estimating section 30 estimates the displacement of the head of the occupant based on the acceleration and the like detected in step ST1 and the data of the occupant behavior model shown in FIG. 3 (ST4).

Then, the control section 40 calculates the movement amount of the display screen of the display 60 based on the displacement of the vehicle estimated in step ST3 (ST5). The control section 40 obtains the displacement amount of the position of the occupant's eye based on the displacement of the head of the occupant estimated in step ST4 and calculates the amount of relative displacement between the display screen of the display 60 and the occupant's eye based on the displacement amount of the position of the occupant's eye and the movement amount calculated in step ST5 (ST6).

The image displacement section 54 calculates the displacement amount of the image to be displayed on the display 60 based on the amount of relative displacement calculated in step ST6 (ST7). The image composition section 53 composites the displayed image, etc., and the marker to be displayed (ST8). Then, the image displacement section 54 shifts the image with the marker (ST9). The display 60 displays the shifted composition image (ST10).

Finally, the control section 40 determines whether the power of the screen is OFF, namely, whether the power of the display 60 is OFF (ST11). When the power of the display 60 is ON (ST11: NO), the processing goes on to step ST2. When the power of the display 60 is OFF (ST11: YES), the processing shown in FIG. 8 is terminated.

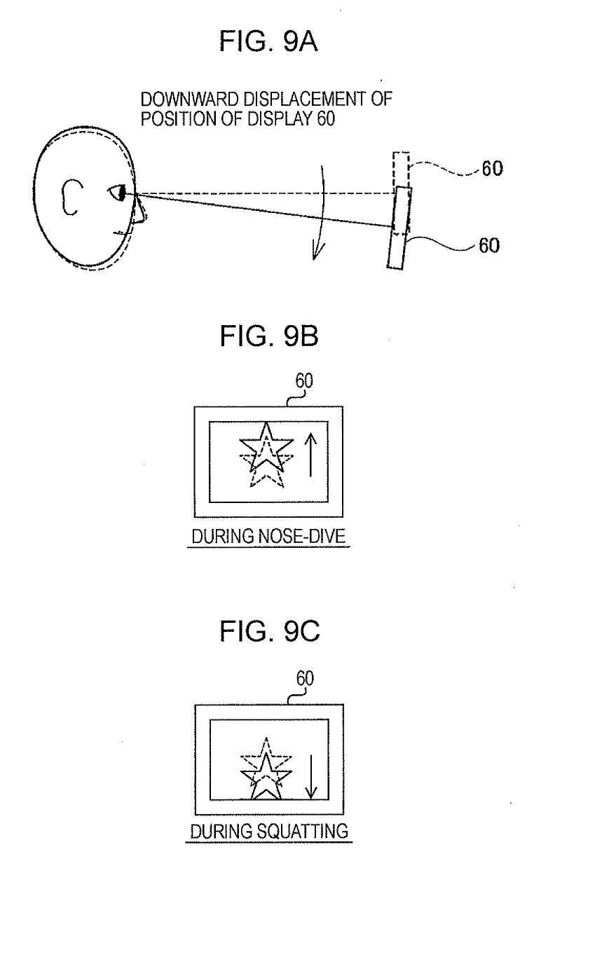

FIGS. 9A to 9C are schematic illustrations each showing the displacement of an image in accordance with the displacement of a vehicle. FIG. 9A shows a relative positional relationship between an occupant and a display screen, FIG. 9B shows the displacement of an image when the nose-dive phenomenon of the vehicle occurs, and FIG. 9C shows the displacement of an image when the squatting phenomenon of the vehicle occurs. In each of FIGS. 9A to 9C, the marker is not shown.

When the vehicle decelerates, a nose-dive phenomenon occurs such that the front portion of the vehicle tilts down. Owing to this, the display screen of the display 60 moves downward as shown in FIG. 9A. At this time, the image displacement section 54 moves the image upward as shown in FIG. 9B so as to cancel out the displacement of the vehicle in the translational direction as described with reference to the flowchart in FIG. 8 and the like. When the vehicle accelerates, the squatting phenomenon occurs such that the front portion of the vehicle tilts up. Owing to this, the display screen of the display 60 moves upward. The image displacement section 54 moves the image downward to cancel out the displacement of the vehicle in the translational direction as shown in FIG. 9C.

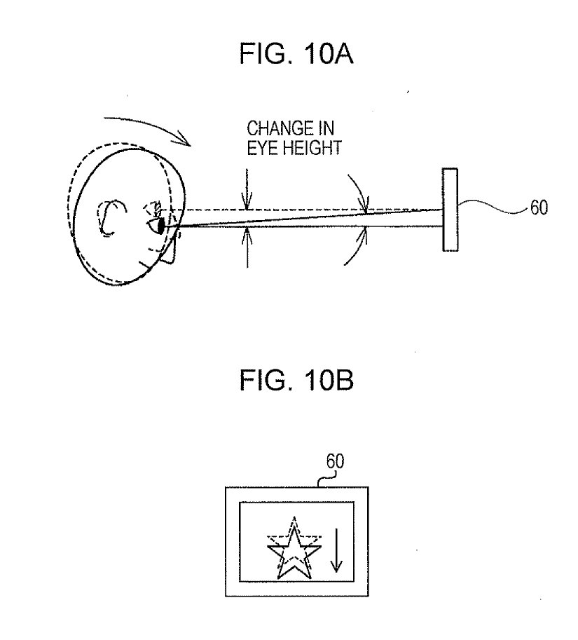

FIGS. 10A and 10B are illustrations each showing the displacement of an image in accordance with the displacement of the head of an occupant. FIG. 10A shows a relative positional relationship between an occupant and a display screen, and FIG. 10B shows the displacement of an image. In each of FIGS. 10A and 10B, the marker is not shown.

When the vehicle decelerates, the head of the occupant tends to tilt down. Owing to this, the height position of occupants eye moves downward as shown in FIG. 10A. At this time, the image displacement section 54 moves the image downward so as to cancel out the displacement of the occupant as shown in FIG. 10B.

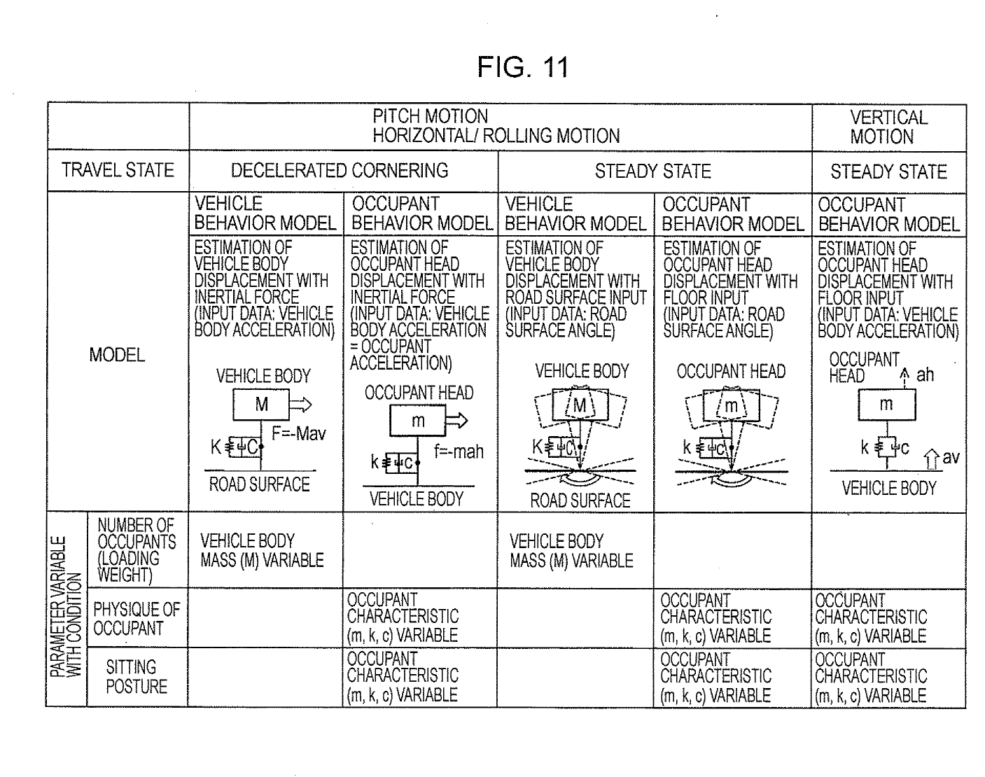

FIG. 11 is a table showing the details of estimation of the displacement of a vehicle and the displacement of the head of an occupant in various travel states. First, FIG. 11 describes the estimation of the displacement of the vehicle utilizing the vehicle behavior model during a decelerated cornering travel state. As described with reference to FIG. 2, when the deceleration av is applied to the vehicle body of this vehicle behavior model, the vehicle body moves forward by a predetermined amount (in the direction indicated by the arrow shown in the drawing). The vehicle motion estimating section 20 stores the data of the movement direction and the movement amount of the vehicle body obtained in advance for the deceleration av applied to the vehicle behavior model. When the vehicle motion detecting section 10 detects the deceleration av, the vehicle motion estimating section 20 estimates the movement direction and the movement amount of the vehicle body based on the stored data. The mass M of the vehicle body varies in accordance with the number of occupants (loading weight).

Next, FIG. 11 describes the estimation of the displacement of the head of the occupant utilizing the occupant behavior model during the decelerated cornering travel state. As described with reference to FIG. 3, when the deceleration ah is applied to the head of the occupant by the occupant behavior model, the head of the occupant moves forward by a predetermined amount (in the direction indicated by the arrow shown in the drawing). The occupant motion estimating section 30 stores the data of the movement direction and the movement amount of the head of the occupant obtained in advance for the deceleration ah applied to the occupant behavior model. When the vehicle motion detecting section 10 detects the deceleration ah, the occupant motion estimating section 30 estimates the movement direction and the movement amount of the head of the occupant based on the stored data. The mass m of the occupant's head, the spring modulus k and the damping coefficient c vary in accordance with the type of physique and sitting posture of the occupant.

Even when the vehicle is in a steady travel state, displacement of the vehicle body may occur and a displacement of the head of the occupant may occur if the slope of the road surface varies. The estimation of the displacement of the vehicle body is next described by FIG. 11 utilizing the vehicle behavior model when the slope of the road surface varies in the steady travel state. In this case, the vehicle image-displaying device 1 recognizes the variation in the road surface on the basis of signal values sent from the acceleration sensor and the angular speed sensor. The vehicle motion estimating section 20 stores the data of the movement direction and the movement amount of the vehicle body obtained in advance for the variation in the road surface applied to the vehicle behavior model. When the variation in the road surface is detected, the vehicle motion estimating section 20 estimates the movement direction and the movement amount of the vehicle body based on the stored data. The mass M of the vehicle body varies in accordance with the number of occupants (loading weight).

FIG. 11 further describes the estimation of the displacement of the head of the occupant utilizing the occupant behavior model when the slope of the road surface varies during the steady travel state. Similarly to the case described above, the occupant motion estimating section 30 stores the data of the movement direction and the movement amount of the head of the occupant obtained in advance for the variation in the road surface applied to the occupant behavior model. When the variation in the road surface is detected, the occupant motion estimating section 30 estimates the movement direction and the movement amount of the head of the occupant based on the stored data. The mass m of the occupant's head, the spring modulus k and the damping coefficient c vary in accordance with the type of physique and sitting posture of the occupant.

Even when the vehicle is in the steady travel state, a displacement of the head of the occupant may still occur because the vehicle moves up and down when the vehicle travels over a bump on the road surface. Hence, FIG. 11 describes the estimation of the displacement of the head of the occupant utilizing the occupant behavior model when the vehicle travels over a bump on the road surface in the steady travel state. In this case, the acceleration av of the vehicle in the vertical direction is detected based on signal values sent from the acceleration sensor and the angular speed sensor. The occupant motion estimating section 30 stores the data of the movement direction and the movement amount of the head of the occupant obtained in advance for the acceleration av in the vertical direction applied to the occupant behavior model. When the acceleration av in the vertical direction is detected, the occupant motion estimating section 30 estimates the movement direction and the movement amount of the head of the occupant based on the stored data. The mass m of the occupant's head, the spring modulus k and the damping coefficient c vary in accordance with the type of physique and sitting posture of the occupant.

As described above, with the vehicle image-displaying device 1 for displaying images in vehicles and its method according to the first embodiment, the image is displaced so as to cancel out the detected displacement of the vehicle and the detected displacement of the head of the occupant. When the image is displaced, the markers are moved in the same direction as the displacement direction of the image by the same amount as the displacement amount of the image. Thus, the presence of the marker(s) allows the user to easily recognize the motion of the image. In addition, at least one of the pair of markers diagonally disposed adjacent to the upper and lower sides of the display screen, and the pair of markers diagonally disposed adjacent to the left and right sides of the display screen, is displayed. Accordingly, no marker appears at the center of the image. Since each of the markers is adjacent to one of the sides of the screen, the user recognizes the marker mainly in the user's peripheral vision, and thereby the obstruction may be effectively reduced as compared with the related art. Further, although a fixed marker is not displayed on the image itself, each of the sides of the screen serves the function of the fixed marker. Accordingly, obstruction of the image by a fixed marker is avoided. Thus, the obstruction given to the user is reduced, and the user can easily recognize the motion of the image.

Since the marker is the character string, graphic, or symbol indicating the condition or state of the vehicle and/or the in-vehicle devices, the condition or state call be provided to the user merely by way of the marker. This further reduces the obstruction as compared with the case where the marker has no meaning. Further, the horizontal lengths of the markers adjacent to the upper and lower sides are larger than the vertical lengths thereof, whereas the vertical lengths of the markers adjacent to the left and right sides are larger than the horizontal lengths thereof. Accordingly, the vertical lengths of the markers adjacent to the upper and lower sides can be prevented from increasing and extending to the center portion of the image. Also, the horizontal lengths of the markers adjacent to the left and right sides can be prevented from increasing and extending to the center portion of the image. The obstruction is farther reduced.

When each of the markers is displayed adjacent to a side of the screen, the marker may have a contrast different from that of an image displayed between the side of the screen and the marker. At this time, it is known that the contrast sensitivity discriminated in the motion direction becomes the maximum when the spatial frequency of the image is 1 cycle/degree (Burr, D. C. and Ross, J., 1982). Also, it is known that the threshold of the minimum motion for the relative motion becomes the minimum when the spatial frequency of the image is 0.5 cycles/degree (Golomb, B., Andersen, R. A. and Nakayama, K., 1985). Accordingly, the marker is spaced by a predetermined amount so as to be away from the side of the screen in a stationary state such that the spatial frequency of the pattern provided by the image in the area between the side of the screen and the marker ranges from 0.2 to 2.0 cycles/degree, thereby easily detecting the motion of the marker. Thus, the uncomfortable feeling is efficiently diminished.

When the marker is moved, a part of the marker or the entire marker may be expressed so as to be moved outside the screen. Accordingly, the incongruous feeling and uncomfortable feeling can be further reliably diminished as compared with the case where the side of the screen functions as the limit for the movement of the marker.

A device 2 for displaying images in vehicles according to the second embodiment is similar to that in the first embodiment, but differs from the device 1 for displaying images in vehicles of the first embodiment both in its configuration and its processes, as is described in detail below.

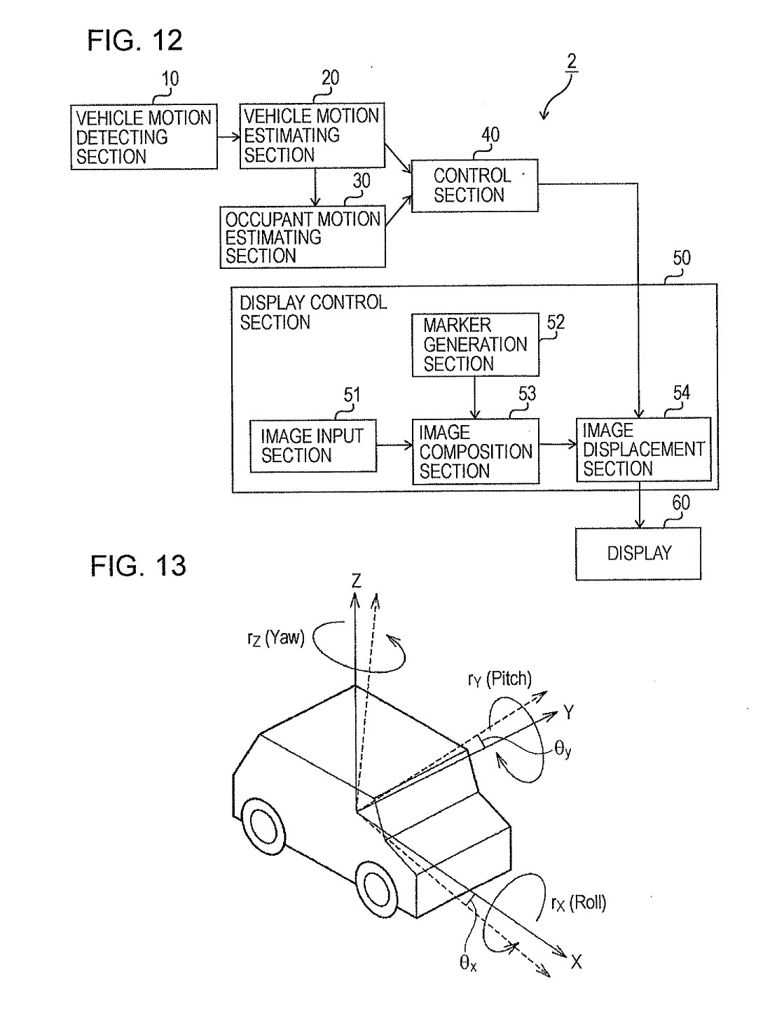

FIG. 12 is a block diagram showing the configuration of the vehicle image-displaying device 2 according to the second embodiment. In this vehicle image-displaying device 2, the vehicle motion estimating section 20 estimates the roll rotation of the vehicle. The control section 40 obtains the displacement amount of marker according to the roll rotation of the vehicle. The marker generation section 52 generates the marker at the position corresponding to the displacement amount. Details are next discussed.

The vehicle motion estimating section 20 according to the second embodiment estimates the amount of roll rotation on the basis of the angular speed detected by the vehicle motion detecting section 10. FIG. 13 is a schematic illustration showing estimates of the amount of roll rotation by the vehicle motion estimating section 20 shown in FIG. 12.

For example, when the vehicle is turned while decelerating due to breaking, the nose-dive phenomenon of the vehicle occurs. This causes the axis of the angular speed sensor in the roll direction to tilt by θx in the pitch direction with respect to the X-axis. When the axis of the angular speed sensor in the roll direction tilts by Ox in the pitch direction with respect to the X-axis, the rotational component in the yaw direction may be mixed with the detection value of the angular speed sensor. In particular, the angular speed in the yaw direction during the turning of the vehicle is markedly larger than those in the roll direction and the pitch direction. Accordingly, if the rotational component in the yaw direction is mixed, an error may occur in the detection value of the roll motion.

The vehicle motion estimating section 20 obtains the pitch angle θx based on the detection value of the pitch motion detected by the angular speed sensor in the pitch direction (about the Y-axis), calculates the mixed rotational component in the yaw direction by using the pitch angle Ox and corrects the detection value of the roll motion. Specifically, the vehicle motion estimating section 20 calculates a yaw angular speed component θRoll (Yaw) mixed with the detection value in the roll direction (roll angular speed θRoll) using the relational expression of θRoll (Yaw)=−θYaw×sin (θx), where θYaw is the detection value in the yaw direction (yaw angular speed).

Then, the vehicle motion estimating section 20 calculates the detection value in the roll direction after the mixed yaw angular speed component θRoll (Yaw) is eliminated (i.e., corrected roll angular speed θRoll′) using the relational expression of θRoll′=θRoll−θRoll (Yaw).

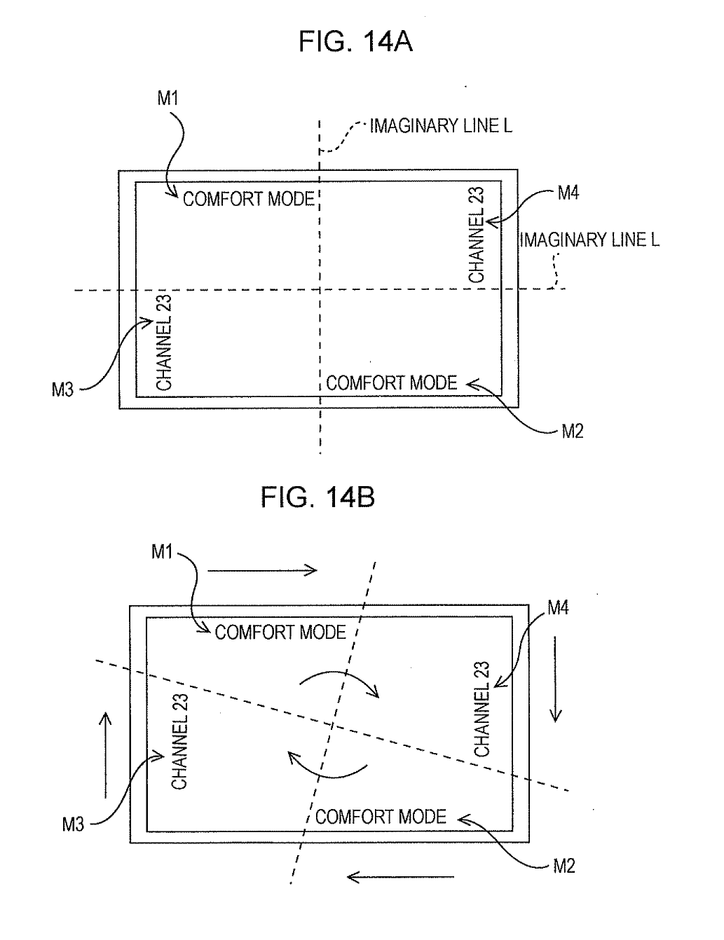

The control section 40 obtains the displacement amount of the markers based on the information of the corrected roll angular speed θRoll′ obtained as described above and transmits the information of the displacement amount to the marker generation section 52. The marker generation section 52 determines the positions of the markers based on the information of the displacement amount and generates the markers at the determined position. At this time, the marker generation section 52 determines the positions of the markers with reference to an imaginary line. FIGS. 14A and 14B are schematic illustrations each showing a method of generating a marker by the marker generation section 52 shown in FIG. 12. FIG. 14A shows markers when the vehicle is not in roll rotation, and FIG. 14B shows markers when the vehicle is in the roll rotation.

When the vehicle is not in the roll rotation, the markers M1 to M4 are disposed as shown in FIG. 14A. In particular, the marker M1 is located near the upper side (specifically, at an upper left side portion) of the screen, the marker M2 is located near the lower side (specifically, at a lower right side portion) of the screen, the marker M3 is located near the left side (specifically, at a lower left side portion) of the screen, and the marker M4 is located near the right side (specifically, at an upper right side portion) of the screen. A straight line connecting respective opposing pairs of markers defines an imaginary line L as shown.

On the other hand, when the vehicle is in the roll rotation, the markers M1 to M4 are disposed as shown in FIG. 14B. In particular, when the vehicle is in a counterclockwise roll rotation, the imaginary line L is rotated in a direction (clockwise) opposite to the roll rotation direction. At this time, the pair of markers M1 and M2 located near the upper and lower sides is moved to come close to each other in the horizontal direction. Also, the pair of markers M3 and M4 located near the left and right sides is moved to come close to each other in the vertical direction. Accordingly, when the markers are displayed on the display 60 in this way, the user recognizes the markers such that the displacement of the vehicle due to the roll rotation is canceled out. This lightens the incongruous and uncomfortable feelings that can result from the roll rotation. In particular, only the markers M1 to M4 are moved as shown in FIG; 14B, but the roll rotation is not applied to the entire image. This can decrease the processing load.

While the example shown in FIG. 14B describes the case where the vehicle is in the counterclockwise roll rotation, similar effects can be obtained in the case where the vehicle is in a clockwise roll rotation. When the vehicle is in the clockwise roll rotation, the pair of markers M1 and M2 located near the upper and lower sides is moved away from each other in the horizontal direction. Also, the pair of markers M3 and M4 located near the left and right sides is moved away from each other in the vertical direction.

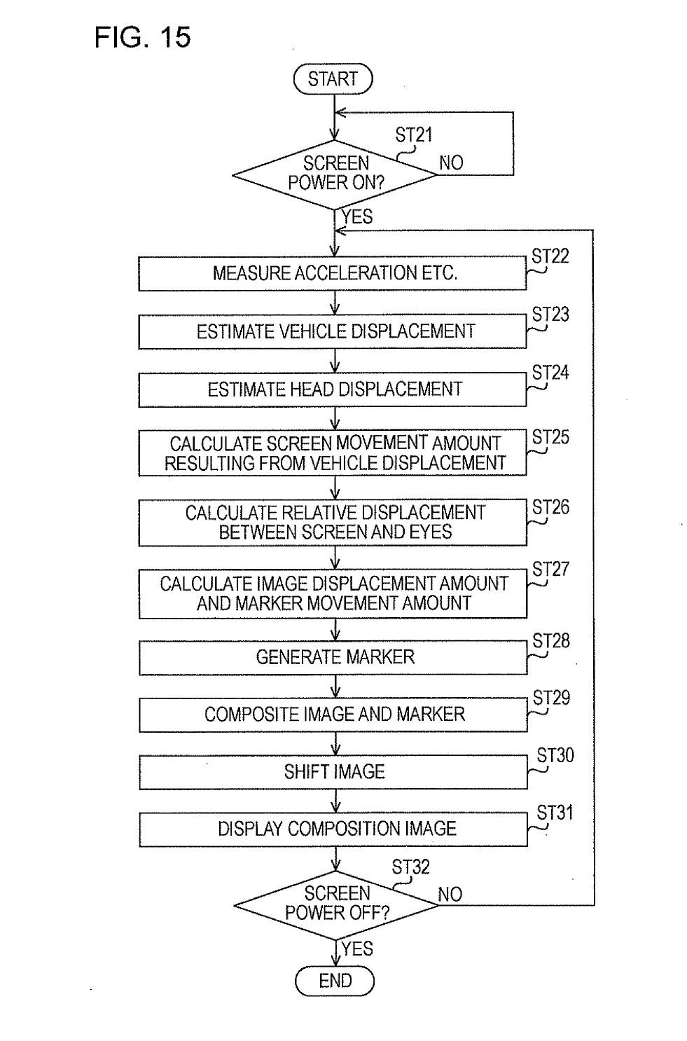

FIG. 15 is a flowchart showing a vehicle image-displaying method for displaying images according to the second embodiment. Since the procedures of steps ST21 to ST26 and ST29 to ST32 are similar to the procedures of steps ST1 to ST6 and ST9 to ST12, respectively, shown in FIG. 8 for moving the image so as to cancel out the displacement of the occupant, the description for the similar procedures is omitted.

After the amount of relative displacement between the display screen of the display 60 and the occupant's eye is calculated (ST26), the image displacement section 54 calculates the displacement amount of the image to be displayed on the display 60 based on the amount of relative displacement calculated in step ST26 (ST27). Then, the marker generation section 52 calculates the displacement amount of the marker to be displayed on the display 60 based on the amount of relative displacement (amount of roll rotation) calculated in step ST26 (ST27). The marker generation section 52 next determines the positions of the markers so as to cancel out the roll rotation of the vehicle and generates the markers at the determined positions (ST28). After this, the procedures of the step ST29 and later steps are executed.

With the device 2 for displaying images in vehicles according to the second embodiment, similarly to the first embodiment the obstruction given to the user can be reduced, and the user can easily recognize the motion of the image. The easy recognition further reduces the obstruction, and the uncomfortable feeling is efficiently diminished. Thus, the incongruous and uncomfortable feelings sometimes resulting from the display can be further reliably diminished.

Further, according to the second embodiment the pair of markers are moved so as to come close to or away from each other in the horizontal direction or the vertical direction. Thereby, an imaginary line connecting the pair of markers is rotated in the direction opposite to the roll rotation direction so as to cancel out the detected displacement of the roll rotation of the vehicle. Accordingly, the incongruous and uncomfortable feelings of the displayed image due to the roll rotation of the vehicle can be reduced. In particular, this can occur without rotation of the image, decreasing processing load as compared with the case in which the image is rotated.

As is clear from the above disclosure, the device 1, 2 can be implemented using a microcomputer including central processing unit (CPU), input and output ports (I/O) receiving certain data described herein, random access memory (RAM), keep alive memory (KAM), a common data bus and read only memory (ROM) as an electronic storage medium for executable programs and certain stored values as discussed herein. The functional (or processing) units of the device described herein, that is, motion detecting section 10, vehicle motion estimating section 20, occupant motion estimating section 30, control section 40 and display control section 50, including its image input section 51, marker generation section 52, image composition section 53 and image displacement section 54, can be implemented in software as the executable programs using known programming techniques and the disclosure herein, or could be implemented in whole or in part by separate hardware in the form of one or more integrated circuits (IC). Provided with the proper input data as described herein, known methods of displaying input data on the display 60 can be used.

Although the invention has been described according to the above embodiments, it should be understood that the invention is not limited to the above embodiments, and may be modified or may employ a combination of the above embodiments. For example, while the displacement of the vehicle and the displacement of the head of the occupant are estimated in the first embodiment, only one of the displacements may be estimated. Also, in the second embodiment, if the displacement of the vehicle (in the translational direction and for the roll rotation) is estimated, it is not necessary to estimate the displacement of the head of the occupant.

Accordingly, the above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A device for displaying images in a vehicle including a display unit having a screen, the device comprising:
a motion estimating unit operable to estimate an estimated displacement value corresponding to at least one of an estimated displacement of the vehicle and an estimated displacement of a head of an occupant; and
a display control unit operable to:
display an image on the screen;
selectively displace the image with respect to the screen according to the estimated displacement value;
display a pair of markers disposed along opposing edges of the screen; and
move the pair of markers in accordance with a displacement direction and a displacement amount of the image when the image is displaced.

2. The device according to claim 1 wherein each marker of the pair of markers disposed across a diagonal of the screen in an opposite side.

3. The device according to claim 1 wherein the pair of markers diagonally disposed along opposing edges of the screen.

4. The device according to claim 3 wherein the pair of markers is a first pair of markers; and wherein the display control unit is further operable to:
display a second pair of markers diagonally disposed along second opposing edges of the screen.

5. The device according to claim 4 wherein the first pair of markers is diagonally disposed at upper and lower edges of the screen, and the second pair of markers is diagonally disposed at left and right edges of the screen; and wherein a horizontal length of each of the first pair of markers is larger than a vertical length thereof, and a vertical length of each of the second pair of markers is larger than a horizontal length thereof.

6. The device according to claim 4 wherein the first pair of markers is diagonally disposed at upper and lower edges of the screen, and the second pair of markers is diagonally disposed at left and right edges of the screen; and wherein the display control unit is further operable to move both the first pair of markers and the second pair of markers in accordance with the displacement direction and the displacement amount of the image when the image is displaced.

7. The device according to claim 5 wherein the first pair of markers is diagonally disposed at upper and lower edges of the screen, and the second pair of markers is diagonally disposed at left and right edges of the screen; wherein the motion estimating unit is farther operable to estimate an estimated roll rotation; and wherein the display control unit is further operable to move at least one of the first pair of markers toward or away from one another along the upper and lower edges of the screen and the second pair of markers toward or away from one another along the left and right edges of the screen to thereby rotate a respective imaginary line connecting the respective first and second pairs of markers in a direction opposite to the estimated roll rotation.

8. The device according to claim 7 wherein the display control unit is further operable to selectively displace the image with respect to the screen according to the estimated displacement value by displacing the image with respect to the screen when the estimated displacement value indicates at least one of a yaw change and a pitch change of the vehicle and by maintaining an original orientation of the image when the estimated roll rotation indicates that the estimated displacement value is due to a roll rotation of the vehicle.

9. The device according to claim 1 wherein the display control unit is further operable to selectively displace the image with respect to the screen according to the estimated displacement value by displacing the image with respect to the screen when the estimated displacement value indicates at least one of a yaw change and a pitch change of the vehicle and by maintaining an original orientation of the image when the estimated displacement value indicates a roll rotation of the vehicle.

10. The device according to claim 1 wherein the display control unit is further operable to:
move the pair of markers in the same direction as the displacement direction of the image and by the same amount as the displacement amount of the image when the image is displaced.

11. The device according to claim 1 wherein the motion estimating unit is further operable to calculate an estimated roll rotation; and wherein the display control unit is operable to move each marker of the pair of markers toward or away from one another along a respective edge of the screen according to the estimated roll rotation to thereby rotate an imaginary line connecting the markers of the pair of markers in a direction opposite to the estimated roll rotation.

12. The device according to claim 1 wherein each marker of the pair of markers is selected from the group consisting of a character string, a graphic, a symbol, and combinations thereof.

13. The device according to claim 1 wherein each marker of the pair of markers has a first dimension along a respective adjacent edge of the screen that is larger than a second dimension transverse to the respective adjacent edge of the screen.

14. The device according to claim 1 wherein the display control unit is further operable to space each marker of the pair of markers from a respective adjacent edge of the opposing edges of the screen to have a spatial frequency ranging from 0.2 to 2.0 cycles/degree.

15. The device according to claim 1 wherein the display control unit is further operable to remove all or a part of each marker of the pair of markers from a viewable area of the screen.

16. A device for displaying images in vehicles, comprising:
means for estimating an estimated displacement value corresponding to at least one of a displacement of a vehicle and a displacement of the head of an occupant;
means for selectively displacing an image displayed on the screen according to the estimated displacement value; and
means for moving a pair of markers disposed along opposing edges of the screen in accordance with a displacement direction and a displacement amount of the image when the image is displaced.

17. A method of displaying images in a vehicle including a display unit having a screen, the method comprising:
estimating an estimated displacement value corresponding to at least one of a displacement of a vehicle and a displacement of the head of an occupant;
selectively displacing an image displayed on the screen according to the estimated displacement value; and
moving a pair of markers disposed along opposing edges of the screen in accordance with a displacement direction and a displacement amount of the image when the image is displaced.

18. The method according to claim 17 wherein moving the pair of markers diagonally disposed along opposing edges of the screen in accordance with the displacement direction and the displacement amount of the image when the image is displaced further comprises:
moving the pair of markers in the same direction as the displacement direction of the image and by the same amount as the displacement amount of the image when the image is displaced.

19. The method according to claim 17 wherein moving the pair of markers diagonally disposed along opposing edges of the screen in accordance with the displacement direction and the displacement amount of the image when the image is displaced further comprises:
removing all or a part of each marker of the pair of markers from a viewable area of the screen.

20. The method according to claim 17 wherein selectively displacing an image displayed on the screen according to the estimated displacement value further comprises:
displacing the image with respect to the screen when the estimated displacement value indicates at least one of a yaw change and a pitch change of the vehicle; and
maintaining an original orientation of the image when the estimated displacement value indicates a roll rotation of the vehicle.

21. The method according to claim 17 wherein the pair of markers includes a first pair of markers diagonally disposed at upper and lower edges of the screen and a second pair of markers diagonally disposed at left and right edges of the screen; and wherein moving the pair of markers diagonally disposed along opposing edges of the screen in accordance with the displacement direction and the displacement amount of the image when the image is displaced further comprises moving both the first pair of markers and the second pair of markers in accordance with the displacement direction and the displacement amount of the image when the image is displaced.

22. The method according to claim 17, further comprising:
calculating an estimated roll rotation; and
moving each marker of the pair of markers toward or away from one another along a respective edge of the screen according to the estimated roll rotation to thereby rotate an imaginary line connecting the markers of the pair of markers in a direction opposite to a direction of the estimated roll rotation
